(19) United States
(12) Patent Application Publication
(10) Pub. No.: US 2009/0240844 A1
(43) Pub. Date: Sep. 24, 2009

(54) METHOD FOR ADDING HARDWARE

(75) Inventor: Yi-Lung Lee, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/053,302

(22) Filed: Mar. 21, 2008

(51) Int. Cl. G06F 13/10

(52) U.S. Cl. 710/16

(57) ABSTRACT

A method for adding hardware is provided. The method is adapted for connecting a Plug-and-Play (PNP) device to a computer through a universal serial bus port (USB port). The method includes activating an enumeration process. According to the enumeration process, a filter driver identifies a device type of the PNP device. If the device type is an excluded device type, the filter driver terminates the enumeration process. If the device type is an allowable device type, the enumeration process continuously progresses to add the PNP device onto the computer.

### BACKGROUND OF THE INVENTION

1. Field of the Invention

The present invention generally relates to a method of controlling peripheral systems, in particular, to a method for adding hardware.

2. Description of Related Art

In the past, computers must be coupled through various connection interfaces to different peripheral apparatuses, for example, connected to modems and mouses through serial ports, and connected to printers through parallel ports, etc. Thus, it is difficult to manage the input/output interfaces of various specifications. Moreover, the computer hosts must be shut down before connecting or detaching the peripheral apparatuses, which is inconvenient in use.

Accordingly, a Universal Serial Bus (USB) standard is set forth in the field to support a plug and play (PNP) installation function. Since the USB adopts a hot-plugging design, the computer hosts without system shut down or restart can use the peripheral apparatuses through the USB. Currently, many electronic devices, such as keyboards, scanners, flash disks, and digital cameras are provided with USB interfaces.

However, based on the requirements in use, a user may need to lock the USB ports on a computer host. If the USB ports are locked by hardware or disabled in a computer administrator, and thus the PNP function of the USB ports is disabled to all the device types. That is to say, the USB ports are not selectively locked, but the USB ports are locked to all added devices. Therefore, when the user needs to connect a specific device to the computer through the USB ports, the user must manually activate the function of the USB ports, which is inconvenient in use for the user.

### SUMMARY OF THE INVENTION

The present invention is directed to a method for adding hardware, capable of enhancing flexibility in using the USB ports.

The present invention is further directed to a method for adding hardware, capable of selectively locking the USB ports to some PNP devices.

The present invention provides a method for adding hardware, applicable to at least one USB port on a computer including a plug-and-play (PNP) manager and a filter driver. The method includes the following steps. First, a PNP device is connected to the USB port. The PNP manager activates an enumeration process to send a query device relation. The query device relation is used for querying a level relation between the PNP device and a device tree. Then, the filter driver identifies a device type of the PNP device according to the query device relation.. If the device type is an excluded device type, the enumeration process is terminated. If the device type is an allowable device type, the enumeration process continuously progresses to add a device node corresponding to the PNP device onto the device tree according to the level relation.

In the method for adding hardware according to an embodiment of the present invention, the PNP manager maintains the device tree.

In the method for adding hardware according to an embodiment of the present invention, the step of terminating the enumeration process further includes a USB Hub driver stopping creating a physical device object corresponding to the PNP device.

In the method for adding hardware according to an embodiment of the present invention, the step of terminating the enumeration process further includes the PNP manager stopping searching a device driver corresponding to the PNP device.

In the method for adding hardware according to an embodiment of the present invention, the step of identifying the device type of the PNP device further includes classifying the PNP device into the excluded device type and the allowable device type according to a customized condition.

In the method for adding hardware according to an embodiment of the present invention, during terminating the enumeration process, a device removal prompt does not appear on a user interface displayed on a display of the computer.

The present invention further provides a method for adding hardware, adapted to connecting a PNP device to a computer including a filter driver through a USB port. The method includes the following steps. An enumeration process is activated. The filter driver then identifies a device type of the PNP device according to the enumeration process. If the device type is an excluded device type, the filter driver terminates the enumeration process. If the device type is an allowable device type, the enumeration process continuously progresses to add the PNP device onto the computer.

In the method for adding hardware according to an embodiment of the present invention, the step of terminating the enumeration process further includes a USB Hub driver stopping creating a physical device object corresponding to the PNP device.

In the method for adding hardware according to an embodiment of the present invention, the step of terminating the enumeration process further includes stopping searching a device driver corresponding to the PNP device.

In the method for adding hardware according to an embodiment of the present invention, the step of identifying the device type of the PNP device further includes classifying the PNP device into the excluded device type and the allowable device type according to a customized condition.

In the method for adding hardware according to an embodiment of the present invention, during terminating the enumeration process, a device removal prompt does not appear on a user interface displayed on a display of the computer.

In view of the above, in the present invention, when the PNP device is physically connected to the USB port of the computer, the PNP manager activates the enumeration process, and the filter driver identifies if the PNP device connected to the computer is an allowable type PNP device or not. When the PNP device is identified by the filter driver to be an excluded device type, the level of the filter driver directly terminates the enumeration process, and thus the user will not perceive any device removal message on the display of the computer. At the beginning of the enumeration process, it is confirmed whether or not to add a device through a software module, so as to selectively allow adding some device types, and to make the USB port on the computer host assuming the locked state to reject excluded device types. Therefore, the USB port on the computer host is selectively locked to some devices, thereby enhancing the flexibility in using the USB port.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a simplified schematic view illustrating processes of a method for adding hardware according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

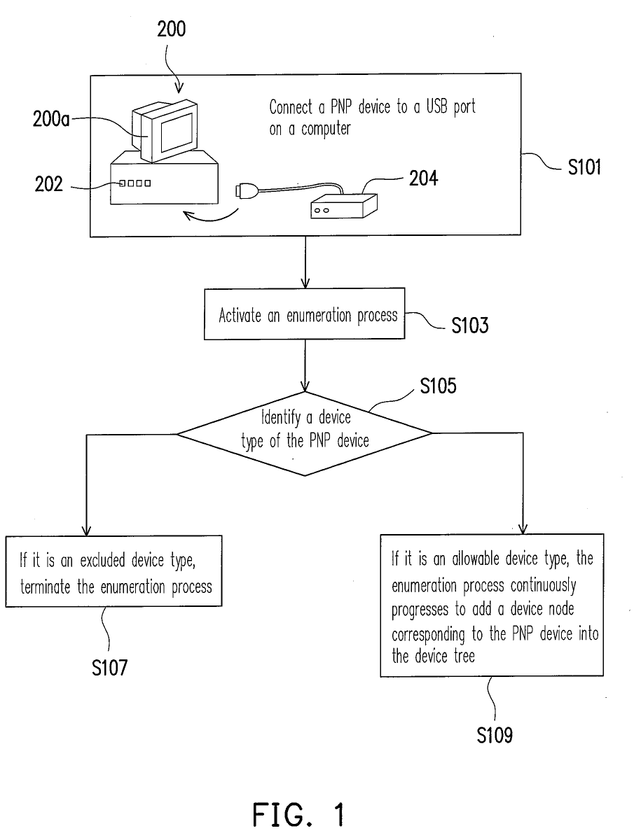

FIG. 1 is a simplified schematic view illustrating processes of a method for adding hardware according to an embodiment of the present invention. Referring to FIG. 1, a computer 200 has at least one Universal Serial Bus port (USB port) 202, and the computer includes a Plug-and-Play manager (PNP manager), a filter driver, and a USB Hub driver. The PNP manager maintains a device tree, and the device tree is used for a computer system to trace available devices and information of the devices in the system. Further, the filter driver is, for example, an upper-level filter driver. First, in a step S101, a PNP device 204 is connected to the USB port 202 on the computer 200. The PNP device 204 is, for example, computer peripherals, such as a mouses, keyboards, touch pads, displays, and potable storage media meeting the USB interface specification.

In a step S103, when the PNP device 204 is connected to the computer 200, the PNP manager in the computer 200 activates an enumeration process, such that the enumeration process sends a query device relation, and the query device relation is used for querying a level relation between the PNP device 204 and the device tree maintained by the PNP manager.

In a step S105, the filter driver in the computer identifies a device type of the PNP device 204 according to the query device relation. The step of identifying the device type of the PNP device 204 further includes classifying the PNP device 204 into an excluded device type and an allowable device type according to a customized condition. That is, the user can decide the device types which are selectively allowed by the USB port (i.e., the allowable device type), for example, a human interface device (HID) including a mouse, touch pad, pen mouse, and keyboard, and rejects some device types (i.e., the excluded device type), for example, the portable storage media, as desired.

Therefore, if the device type of the PNP device 204 is an excluded device type, the enumeration process is terminated (step S107). The step of terminating the enumeration includes the USB Hub driver stopping creating a physical device object corresponding to the PNP device 204 and the PNP manager stopping searching a device driver corresponding to the PNP device 204. During terminating the enumeration process, the USB Hub driver stops creating the corresponding physical device object, so a device removal prompt does not appear on a user interface displayed on a display 200a of the computer.

On the contrary, if the device type of the PNP device 204 is an allowable device type, the enumeration process continuously progresses (step S109). That is, according to the level relation of the PNP device 204 in the device tree, a device node corresponding to the PNP device 204 is added into the device tree, the USB Hub driver establishes a physical device object corresponding to the PNP device 204, and the PNP manager searches the driver of the PNP device 204, so as to add the PNP device 204 onto the computer 200. In this manner, the device information of the PNP device 204 added onto the computer 200 can be found in the device administrator of the computer system.

In view of the above, in the present invention, when the PNP device is physically connected to the USB port on the computer, the PNP manager activates the enumeration process, the filter driver identifies if the PNP device connected to the computer is an allowable type PNP device or not. When the PNP device is identified by the filter driver to be an excluded device type, the level of the filter driver directly terminates the enumeration process, and thus the user will not perceive any device removal message on the display of the computer. At the beginning of the enumeration process, it is confirmed whether or not to add a device through a software module, so as to selectively allow some device types, and to make the USB port on the computer host assuming the locked state to reject the excluded device types. Therefore, the USB port on the computer host is/are selectively locked to some devices, thereby enhancing the flexibility in using the USB port.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adding hardware, adapted to at least one universal serial bus port (USB port) on a computer comprising a plug-and-play (PNP) manager and a filter driver, comprising:
connecting a PNP device to the USB port;
the PNP manager activating an enumeration process to send a query device relation, wherein the query device relation is used for querying a level relation of the PNP device in a device tree;
the filter driver identifying a device type of the PNP device according to the query device relation, wherein:
if the device type is an excluded device type, the filter driver terminates the enumeration process; and
if the device type is an allowable device type, the enumeration process continuously progresses to add a device node corresponding to the PNP device in the device tree according to the level relation.

2. The method for adding hardware according to claim 1, wherein the PNP manager maintains the device tree.

3. The method for adding hardware according to claim 1, wherein the step of terminating the enumeration process further comprises a USB Hub driver stopping creating a physical device object corresponding to the PNP device.

4. The method for adding hardware according to claim 1, wherein the step of terminating the enumeration process further comprises the PNP manager stopping searching a device driver corresponding to the PNP device.

5. The method for adding hardware according to claim 1, wherein the step of identifying the device type of the PNP device further comprises classifying the PNP device into the excluded device type and the allowable device type according to a customized condition.

6. The method for adding hardware according to claim 1, wherein during terminating the enumeration process, a device removal prompt does not appear on a user interface displayed on a display of the computer.

7. A method for adding hardware, adapted to connecting a PNP device to a computer comprising a filter driver through a USB port, comprising:
activating an enumeration process;
the filter driver identifying a device type of the PNP device according to the enumeration process, wherein:
if the device type is an excluded device type, the filter driver terminates the enumeration process; and
if the device type is an allowable device type, the enumeration process continuously progresses to add the PNP device onto the computer.

8. The method for adding hardware according to claim 7, wherein the step of terminating the enumeration process further comprises a USB Hub driver stopping creating a physical device object corresponding to the PNP device.

9. The method for adding hardware according to claim 7, wherein the step of terminating the enumeration process further comprises stopping searching a device driver corresponding to the PNP device.

10. The method for adding hardware according to claim 7, wherein the step of identifying the device type of the PNP device further comprises classifying the PNP device into the excluded device type and the allowable device type according to a customized condition.

11. The method for adding hardware according to claim 7, wherein during terminating the enumeration process, a device removal prompt does not appear on a user interface displayed on a display of the computer.
